(19) United States
(12) Patent Application Publication
(10) Pub. No.: US 2013/0246090 A1
(43) Pub. Date: Sep. 19, 2013

(54) Account Management with Estimate Benefits

(71) Applicant: PASSPORT HEALTH COMMUNICATIONS, INC., Franklin, TN (US)

(72) Inventors: Paul Joseph Hoffman, Mill Valley, CA (US); Lance Clifford Mansfield, Seattle, WA (US)

(73) Assignee: PASSPORT HEALTH COMMUNICATIONS, INC., Franklin, TN (US)

(21) Appl. No.: 13/832,185

(22) Filed: Mar. 15, 2013

Related U.S. Application Data
(60) Provisional application No. 61/611,058, filed on Mar. 15, 2012.

(51) Int. Cl. G06F 19/00

(52) U.S. Cl. CPC G06F 19/328
USPC 705/2

(57) ABSTRACT

Estimate of benefits (EOB) data and healthcare billing data are provided in a single user interface. By providing a display of billing information and EOB information on a same screen, a patient may be enabled to better understand his payment responsibility compared to an amount owed to a healthcare provider. When a patient logs into a healthcare billing account, healthcare billing data may be provided, as well as input fields for entering EOB data. When EOB data is received, the billing data received from the healthcare provider billing system and the EOB data may be displayed in the single user interface. If a total of entered EOB amounts does not equal a total amount owed to the healthcare provider, a notification may be provided.

### CROSS-REFERENCE TO RELATED APPLICATIONS

The present application claims priority to U.S. Provisional Patent Application No. 61/611,058 titled “Account Management with Estimate of Benefits” filed Mar. 15, 2012, the disclosure of which is incorporated herein by reference in its entirety.

### BACKGROUND

Oftentimes costs associated with healthcare services can be difficult to understand. For example, when a patient receives a patient statement from a healthcare provider (e.g., hospital, physician group, etc.), the actual amount owed by the patient may be unclear. Typically, if a patient has insurance, a provider's billing office may submit a claim to the patient's insurance company, the claim listing services provided to the patient during his visit. The insurance company may then use the information in the claim to pay a determined amount for the services. When the insurance company pays, the patient may receive a report from the insurance company called an Explanation of Benefits (EOB), the EOB explaining how the insurance company has processed the claim (e.g., the service performed, the cost of the service performed, the amount the insurance company allows, the amount the patient is responsible for, etc.); however, some insurance companies may not provide EOBs.

Currently, when a patient receives a healthcare bill, it may be unknown to the patient the amount his insurance company or companies have paid or will pay. If an EOB is provided to the patient, he may be required to read and understand the EOB to know what the insurance company is paying, what the insurance company is not paying and why. Oftentimes, a patient may receive a bill from a healthcare provider, but may be hesitant to pay the bill because he may be unsure if the amount on the bill is the amount he actually owes. As can be appreciated, providers may risk being compensated for services provided because of uncertainty of owed amounts.

It is with respect to these and other considerations that the present invention has been made.

### SUMMARY

Embodiments of the present invention provide an electronic filing cabinet of healthcare provider account information and insurance estimate of benefits (EOB) information. A user interface may be provided for displaying billing information and EOB information on a same screen, helping a patient to better understand his payment responsibility compared to an amount owed to a healthcare provider. Payments to healthcare providers may be made more timely when patients are more informed of what part of their bills have been settled by their insurance companies and what part of their bills are still owed.

Consider, for example, a patient receives healthcare services from a healthcare provider. After a period of time, the patient may receive a bill for the healthcare services provided by the provider. The patient may be unsure about how much of his bill will be paid by insurance or if reductions may be applied by the insurance company or companies. Thus, the patient may wait to pay his bill to see if he receives an EOB from his insurance company or if he receives another bill from the provider with an updated patient responsibility amount. The patient may even wait to pay after receiving several bills, still unsure if his insurance company may make further payments. As can be appreciated, a healthcare provider may not receive payment for services rendered for an extended period of time and may have to spend extra money on multiple billings and possibly utilizing a credit collector to collect payments.

Embodiments provide an electronic filing cabinet for storing and managing EOB information (e.g., an amount not covered by an insurance company, an amount applied to a patient's deductible, a co-pay amount, a co-insurance amount, etc.) with healthcare provider billing information, allowing a patient to be more informed of charges, payments applied, and amounts owed. Embodiments provide for a marriage of EOB information and a provider billing statement to help patients understand their share of a healthcare cost.

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

### BRIEF DESCRIPTION OF DRAWINGS

FIG. 1 is a simplified block diagram of a high-level system architecture with which embodiments of the invention may be implemented.

FIG. 2 is an illustration of an example screenshot of a provider billing statement including EOB information.

FIG. 3 is a flow chart of a method of providing an electronic filing cabinet of healthcare provider account information and insurance estimate of benefits information according to an embodiment.

FIG. 4 is a simplified block diagram of a computing device with which embodiments of the present invention may be practiced.

### DETAILED DESCRIPTION

Embodiments provide a personal electronic filing cabinet of hospital account information and insurance EOB information for a patient. Embodiments may be utilized to provide EOB information with a provider billing statement, allowing a patient to manage his account(s) and to be more informed of charges, payments applied, and amounts owed. Embodiments provide for a marriage of EOB information and a provider billing statement to help patients understand their share of a healthcare cost.

These embodiments may be combined, other embodiments may be utilized, and structural changes may be made without departing from the spirit or scope of the present invention. The following detailed description is therefore not to be taken in a limiting sense, and the scope of the present invention is defined by the appended claims and their equivalents. Referring now to the drawings, in which like numerals refer to like elements throughout the several figures, embodiments of the present invention and an exemplary operating environment will be described.

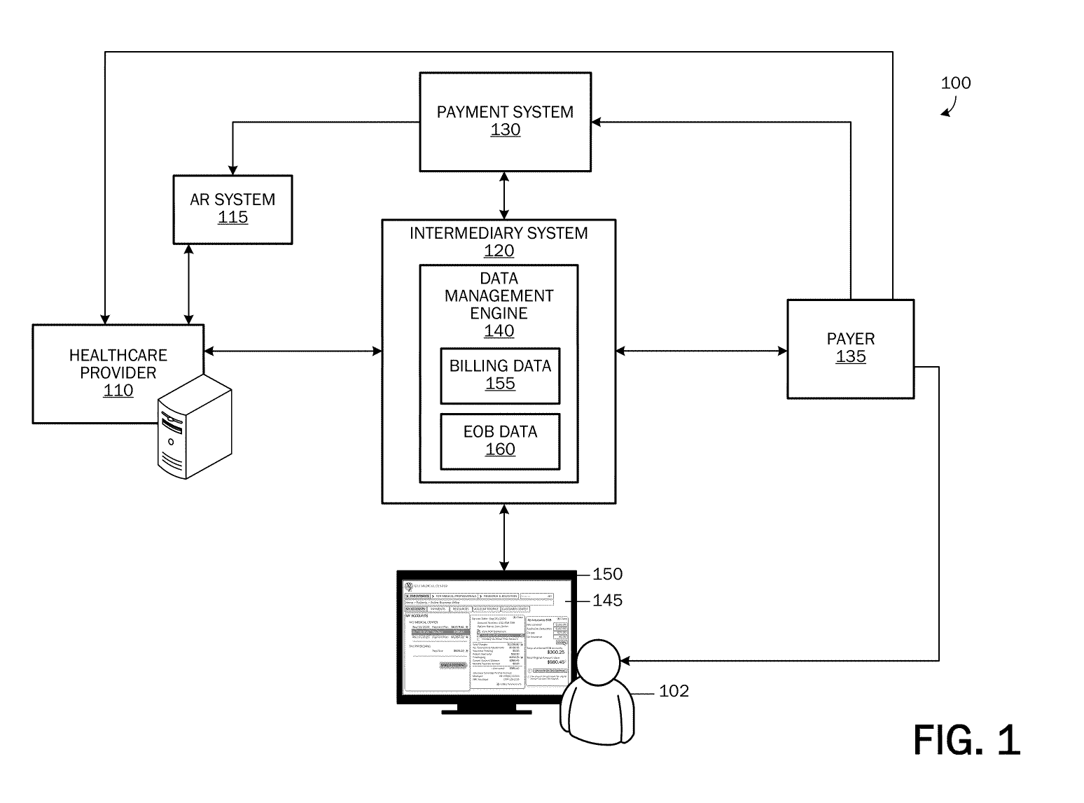

Referring now to FIG. 1, a simplified block diagram of a high-level system architecture 100 with which embodiments of the invention may be implemented is shown. As illustrated, the system 100 includes a healthcare provider 110, which comprises a billing system. The system also includes one or more insurance companies, herein referred to as payers 135. When a patient 102 seeks healthcare services from a healthcare provider 110, the provider may transmit a claim to one or more payers 135. This may be processed electronically, for example, by formatting the claim as an ANSI 837 file and using Electronic Data Interchange to submit the claim file to the payer directly, or via the an intermediary system 120, which may sometimes be referred to as a clearinghouse.

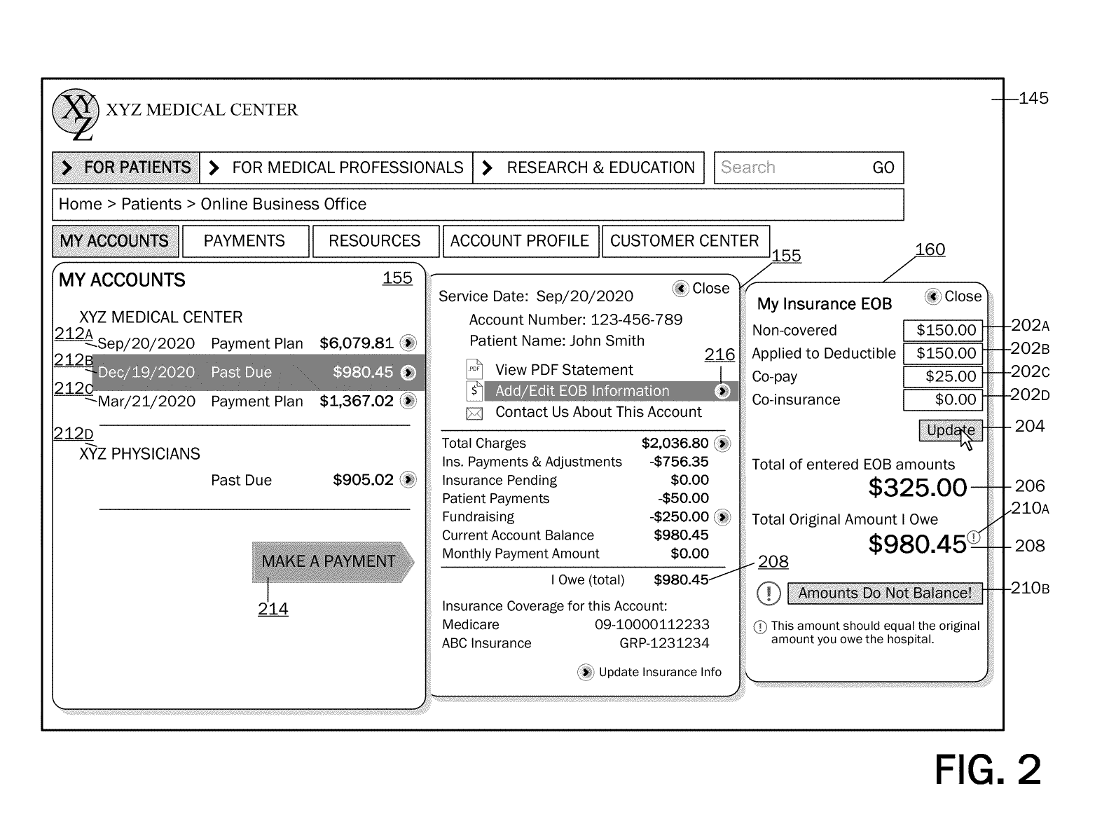

The intermediary system 120 is illustrative of a business or other entity that may include a collection of computers, storage media, or other computing devices operative to provide connectivity and serve as an intermediary between a healthcare provider 110 and payers 135 for transmission and translation of claims information into a specific format required by payers, and for providing application services, to generate and display graphical user interface screens, for example, like the graphical user interface screen 145 illustrated in FIG. 2, and for creating and setting up data transport between a patient 102, an accounts receivable (AR) system 115, and a billing system.

A payer 135 may then process a claim. Approved claims may be reimbursed for a certain percentage of billed services. Failed claims may be denied, and a notice may be sent to the healthcare provider 110, and sometimes to the patient 102 or guarantor of the patient's account. Most commonly, a denied or rejected claim may be returned to a healthcare provider 110 in the form of an explanation of benefits (EOB) 160. An EOB 160 may also be sent to a healthcare provider 110 or a patient 102 upon processing a claim or upon request by the healthcare provider 110 or the patient 102, wherein an EOB 160 typically describes a service performed (e.g., a date of the service, a description and/or payer's code for the service, a name of the healthcare provider 110, and a name of the patient 102), an amount claimed by the healthcare provider 110, an amount that the payer 135 allows (i.e., the amount claimed by the healthcare provider 110 minus any reductions applied by the payer), and an amount for which the patient 102 is responsible.

As described briefly above, the system 100 may include a billing system associated with a healthcare provider 110. The billing system may be utilized for patient billing, collections, remittance posting, charge entry, claims generation, and reporting. The billing system may comprise an accounts receivable system 115 operable to generate a variety of reports, and to allow an application and tracking of receivables and collections. According to embodiments, the accounts receivable system 115 may receive funds in satisfaction of an owed account.

The system 100 may include an electronic payment system 130 operable to allow payments and money transfers to be made through a distributed computing network (e.g., Internet). According to one embodiment, a payment made by a payer 135 or patient 102 through the payment system 130 may be allocated directly to an owed account in an accounts receivable system 115 via the intermediary system 120.

As illustrated in FIG. 1, the billing system 155, the intermediary system 120, and the payment system 130 may be separate systems. As should be appreciated, although illustrated as separate systems, the billing system 155, the intermediary system 120, and the payment system 130 are not limited to such an architecture, and may be implemented in various configurations. For example, the billing system 155, the intermediary system 120, and the payment system 130 may be implemented in a unified system. Alternatively, the billing system 155 and intermediary system 120 may be implemented in a unified system, and the payment system 130 may exist as a separate system.

As described briefly above, billing data 155 associated with an owed account in an accounts receivable system 115 may be presented to a patient 102 or guarantor of the account via the intermediary system 120. According to embodiments, the intermediary system 120 may comprise an account management engine 140 for receiving, storing, and providing billing data 155 and EOB data 160 associated with a patient account. The intermediary system 120 may comprise a web service for allowing a patient 102 or guarantor access to portions of the customer's billing records, for allowing the customer or guarantor to share billing data 155 with one or more third parties, and for allocating a payment made through a payment system 130 to an owed billing account. According to an embodiment, a patient 102 may utilize the web service for entering EOB data 160 via the user interface 145. As illustrated, the user interface 145 may be displayed on a computing device 150, which may be one of various types of computing devices such as a desktop computer, laptop computer, tablet computing device, mobile computing device, mobile communication device, gaming device, network television, etc. According to another embodiment, EOB data 160 may be provided by a healthcare provider 110, and entered by the intermediary system 120. According to yet another embodiment, EOB data 160 may be provided by a payer 135, and entered by the intermediary system 120. When EOB data 160 is received, either from a healthcare provider 110, a payer 135, the intermediary system 120, or from a patient 102, the patient 102 may access and view his account billing data 155 and EOB data 160 in a unified user interface 145 as will be described in greater detail with respect to FIG. 2.

Referring now to FIG. 2, an example of a user interface 145 provided by the intermediary system 120 is illustrated. A patient 102 may access healthcare billing data 155 via the user interface 145. For example, a patient 102 may utilize the user interface 145 to view amounts owed to one or more accounts 212. A selectable payment control 214 may be provided, which when selected, may allow a patient 102 to make a payment on an account 212 via the payment system 130. Upon selection of an account 212, additional billing information 155, such as an account number, insurance information, and payment details may be displayed.

Various functionalities, such as an “add/edit EOB information” functionality control 216 may be provided, which when selected, may provide a display of EOB data 160 that has been previously entered. If EOB data 160 has not been entered, a plurality of input fields 202 may be provided in the user interface 145 for entering insurance EOB data 160. For example a “non-covered” input field 202A may be provided for entering and/or displaying an amount not covered by the payer 135, an “amount applied to deductible” input field 202B for entering and/or displaying an amount paid by the patient 102 applied to a deductible amount associated with the patient's 102 insurance policy, a “co-pay” input field 202C for entering and/or displaying an amount paid out-of-pocket by the patient 102 for a health-care service, and a “co-insurance” input field 202D for entering and/or displaying an amount (oftentimes a percentage amount) required for the patient 102 to pay towards his health insurance bill. An “update” control 204 may be provided, which when selected, may calculate a total of the entered EOB amounts 206. According to an embodiment, the total of entered EOB amounts 206 may be compared with a total amount owed to the healthcare provider 208, which may be provided in the billing data 155. If the total of entered EOB amounts 206 does not equal the total amount owed to the healthcare provider 208, one or more notifications 210 may be displayed.

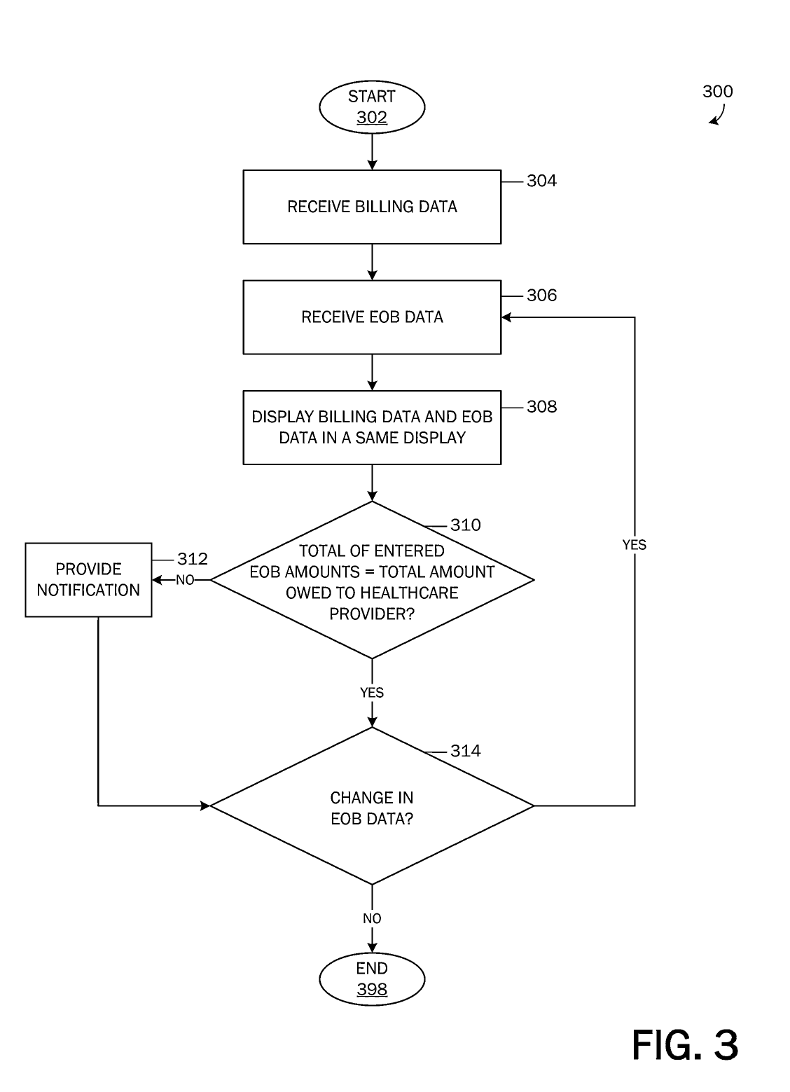

Referring now to FIG. 3, a flow chart of a method 300 of providing an electronic filing cabinet of healthcare provider account billing information 155 and insurance estimate of benefits information 160 according to an embodiment. The method 300 begins at START OPERATION 302 and proceeds to OPERATION 304, where billing data 155 is received. As described above, billing data 155 may be received from a healthcare provider 110 billing system, and may comprise account information associated with a patient 102 such as, but not limited to, owed amounts, healthcare service data, patient information, insurance coverage information, payment amounts, financing information, etc. The billing data 155 may be stored in an electronic filing cabinet at the intermediary system 120 by the account management engine 140, and may be accessible to the patient 102 via a web services interface. A patient 102 may log into his account via the web services interface and may be able to perform various tasks such as, but not limited to, view his billing data 155, make a payment, view a statement, update insurance information, and add or edit EOB information 160.

At OPERATION 306, EOB data 160 may be received. According to an embodiment, the EOB data 160 may be entered by the patient 102 via the user interface 145 as described above with respect to FIG. 2. For example, the patient 102 may receive an EOB statement from a payer 135, and may enter the EOB data 160 into the input fields 202 on the user interface 145. According to another embodiment, the EOB data 160 may be entered by the intermediary system 120. For example, a healthcare provider 110 may receive an EOB statement from a payer 135. The healthcare provider 110 may provide the EOB data 160 to the intermediary system 120, for example, in a healthcare claim payment/advice transaction set (i.e., 835 file), wherein the intermediary system 120 may enter the EOB data 160 into the input fields 202 on the user interface 145. According to another embodiment, the intermediary system 120 may receive an EOB statement from a payer 135, and accordingly, may enter the EOB data 160 into the input fields 202 on the user interface 145. The EOB data 160 may be stored in the electronic filing cabinet at the intermediary system 120 by the account management engine 140, and may be accessed and edited by the patient 102 via the web services interface. Received EOB data 160 may include edited EOB data 160. For example, a patient 102, healthcare provider 110, or the intermediary system 120 may modify an amount in one or more of the EOB data input fields 202.

The method 300 proceeds to OPERATION 308, where the billing data 155 and the received EOB data 160 may be displayed in a same display. That is, when a patient 102 logs into his healthcare provider account, the patient 102 is able to access and view his billing data 155 associated with the healthcare provider 110, and his EOB data 160 associated with one or more payers 135 via the user interface 145. A patient 102 may compare EOB amounts 160 with billing information 155 provided by the healthcare provider 110 to better understand the amount owed. A patient may be enabled to better understand his share of medical costs by providing and presenting the insurance EOB information 160 with the billing information, for example a provider statement 155.

At DECISION OPERATION 310, a determination may be made as to whether the total of the entered EOB amounts 206 (i.e., sum of the amounts entered into the EOB input fields 202 equals the total amount owed to the healthcare provider 208. If the amounts 206 are not equivalent, a notification 210 may be provided at OPERATION 312. The notification 210 may alert the patient 102 that the total of the entered EOB amounts 206 should equal the total amount owed to the healthcare provider 208.

If the total of the entered EOB amounts 206 and the total amount owed to the healthcare provider 208 do equate, or after a notification 210 is provided, the method 300 may proceed to DECISION OPERATION 314, where a determination may be made as to whether EOB information has been modified. For example, a patient 102, healthcare provider 110, and/or the intermediary system 120 may receive a subsequent EOB statement from a payer 135, the subsequent EOB statement including adjusted or modified EOB data 160, such as a modified amount covered or not covered by the payer 135. If EOB information has been modified, the method 300 may return to OPERATION 306, where the patient 102, healthcare provider 110, and/or the intermediary system 120 may enter the modified EOB data 160 into one or more of the EOB data input fields 202 in the user interface 145. The account management engine 140 may store the updated EOB data 160. The updated EOB data 160 may be displayed in the user interface 145 with the billing data 155. The method 300 ends at OPERATION 398.

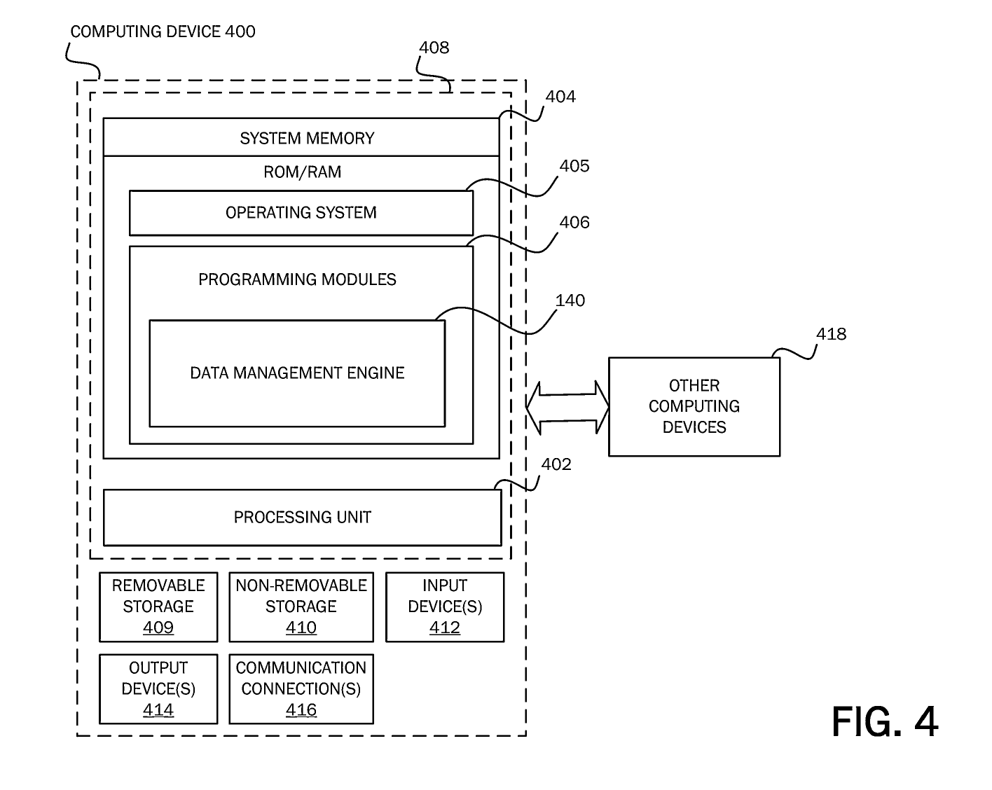

As described above, embodiments of the invention may be implemented via local and remote computing and data storage systems. Such memory storage and processing units may be implemented in a computing device, such as computing device 400 of FIG. 4. Any suitable combination of hardware, software, or firmware may be used to implement the memory storage and processing unit. For example, the memory storage and processing unit may be implemented with computing device 400 or any other computing devices 418, in combination with computing device 400, wherein functionality may be brought together over a network in a distributed computing environment, for example, an intranet or the Internet, to perform the functions as described herein. Such systems, devices, and processors (as described herein) are examples and other systems, devices, and processors may comprise the aforementioned memory storage and processing unit, consistent with embodiments of the invention.

With reference to FIG. 4, a system consistent with embodiments of the invention may include one or more computing devices, such as computing device 400. The computing device 400 may include at least one processing unit 402 and a system memory 404. The system memory 404 may comprise, but is not limited to, volatile (e.g. random access memory (RAM)), non-volatile (e.g. read-only memory (ROM)), flash memory, or any combination. System memory 404 may include operating system 405, one or more programming modules 406, and may include an account management engine 140, wherein the account management engine 140 is a software application having sufficient computer-executable instructions, which when executed, performs functionalities as described herein. Operating system 405, for example, may be suitable for controlling computing device 400's operation. Furthermore, embodiments of the invention may be practiced in conjunction with a graphics library, other operating systems, or any other application program and is not limited to any particular application or system. This basic configuration is illustrated in FIG. 4 by those components within a dashed line 408.

Although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

The computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computing device 400 may also contain a communication connection 416 that may allow device 400 to communicate with other computing devices 418, such as over a network in a distributed computing environment, for example, an intranet or the Internet. Communication connection 416 is one example of communication media. The device 400 may also include input devices 412 and output devices 414 for receiving and outputting data, respectively.

Program modules, such as the account management engine 140, may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable user electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

Embodiments of the present invention, for example, are described above with reference to block diagrams and/or operational illustrations of methods, systems, and computer program products according to embodiments of the invention. For example, FIGS. 1-4 and the described functions taking place with respect to each illustration may be considered steps in a process routine performed by one or more local or distributed computing systems. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

It will be apparent to those skilled in the art that various modifications or variations may be made in the present invention without departing from the scope or spirit of the invention. Other embodiments of the invention will be apparent to those skilled in the art from consideration of the specification and practice of the invention disclosed herein.

All rights including copyrights in the code included herein are vested in and the property of the Applicant. The Applicant retains and reserves all rights in the code included herein, and grants permission to reproduce the material only in connection with reproduction of the granted patent and for no other purpose.

We claim:

1. A method for providing estimate of benefits data with healthcare billing data in a single user interface, the method comprising:
receiving healthcare billing data associated with a patient account with a healthcare provider;
receiving estimate of benefits data associated with a healthcare encounter with the healthcare provider;
storing the received healthcare billing data and received estimate of benefits data; and
providing a display of the received healthcare billing data and received estimate of benefits data in a single user interface.

2. The method of claim 1, further comprising:
determining if an amount owed to the healthcare provider associated with the healthcare encounter equals a total estimate of benefits amount; and
if the amount owed to the healthcare provider associated with the healthcare encounter does not equal the total estimate of benefits amount, providing a notification.

3. The method of claim 1, wherein receiving healthcare billing data associated with a patient account with a healthcare provider comprises receiving healthcare billing data from a healthcare provider billing system.

4. The method of claim 1, wherein receiving estimate of benefits data associated with a healthcare encounter with the healthcare provider comprises receiving one or more of:
an amount not covered by a payer;
an amount applied to a deductible amount;
a co-pay amount; or
a co-insurance amount.

5. The method of claim 4, wherein receiving estimate of benefits data associated with a healthcare encounter with the healthcare provider comprises receiving the estimate of benefits data via the single user interface.

6. The method of claim 1, further comprising providing one or more input fields in the single user interface for allowing a patient to enter estimate of benefits data associated with the healthcare encounter with the healthcare provider.

7. The method of claim 1, further comprising providing one or more input fields in the single user interface for allowing the healthcare provider to enter estimate of benefits data associated with the healthcare encounter with the healthcare provider.

8. The method of claim 1, further comprising providing one or more input fields in the single user interface for allowing an intermediary system to enter estimate of benefits data associated with a healthcare encounter with the healthcare provider.

9. The method of claim 1, further comprising:
receiving modified estimate of benefits data associated with the healthcare encounter with the healthcare provider;
storing the received modified estimate of benefits data;
providing a display of the received healthcare billing data and received modified estimate of benefits data in the single user interface.
determining if the amount owed to the healthcare provider associated with the healthcare encounter equals the total modified estimate of benefits amount; and
if the amount owed to the healthcare provider associated with the healthcare encounter does not equal the total modified estimate of benefits amount, providing a notification.

10. A system for providing an exception-based integrated patient access workflow, the system comprising:
a memory storage; and
a processing unit coupled to the memory storage, wherein the processing unit is operable to:
receive healthcare billing data associated with a patient account with a healthcare provider;
receive estimate of benefits data associated with a healthcare encounter with the healthcare provider;
store the received healthcare billing data and received estimate of benefits data; and
provide a display of the received healthcare billing data and received estimate of benefits data in a single user interface.

11. The system of claim 10, wherein the processing unit is further operable to:
determine if an amount owed to the healthcare provider associated with the healthcare encounter equals a total estimate of benefits amount; and
if the amount owed to the healthcare provider associated with the healthcare encounter does not equal the total estimate of benefits amount, provide a notification.

12. The system of claim 10, wherein the healthcare billing data associated with a patient account with a healthcare provider is received from a healthcare provider billing system.

13. The system of claim 10, wherein the estimate of benefits data associated with a healthcare encounter with the healthcare provider comprises one or more of:
an amount not covered by a payer;
an amount applied to a deductible amount;
a co-pay amount; or
a co-insurance amount.

14. The system of claim 13, wherein the processing unit is further operable to receive the estimate of benefits data via the single user interface.

15. The system of claim 10, wherein the processing unit is further operable to provide one or more input fields in the single user interface for allowing a patient to enter estimate of benefits data associated with the healthcare encounter with the healthcare provider.

16. The system of claim 10, wherein the processing unit is further operable to provide one or more input fields in the single user interface for allowing the healthcare provider to enter estimate of benefits data associated with the healthcare encounter with the healthcare provider.

17. The system of claim 10, wherein the processing unit is further operable to provide one or more input fields in the single user interface for allowing an intermediary system to enter estimate of benefits data associated with the healthcare encounter with the healthcare provider.

18. A computer readable medium containing computer executable instructions which when executed by a computer perform a method of providing estimate of benefits data with healthcare billing data in a single user interface, the method comprising:
receiving healthcare billing data associated with a patient account with a healthcare provider, the healthcare billing data provided by a healthcare provider billing system;
receiving estimate of benefits data associated with a healthcare encounter with the healthcare provider, the estimate of benefits data received via one or more input fields in a user interface and including one or more of:
an amount not covered by a payer;
an amount applied to a deductible amount;
a co-pay amount; or
a co-insurance amount;
storing the received healthcare billing data and received estimate of benefits data;
providing a display of the received healthcare billing data and received estimate of benefits data in the user interface;
determining if an amount owed to the healthcare provider associated with the healthcare encounter equals a total estimate of benefits amount; and
if the amount owed to the healthcare provider associated with the healthcare encounter does not equal the total estimate of benefits amount, providing a notification.

19. The computer readable medium of claim 18, further comprising providing one or more input fields in the single user interface for allowing input of estimate of benefits data associated with the healthcare encounter with the healthcare provider, the input provided by one of:
a patient;
the healthcare provider; or
an intermediary system.

20. The computer readable medium of claim 18, further comprising:
receiving modified estimate of benefits data associated with the healthcare encounter with the healthcare provider;
storing the received modified estimate of benefits data;
providing a display of the received healthcare billing data and received modified estimate of benefits data in the single user interface. determining if the amount owed to the healthcare provider associated with the healthcare encounter equals the total modified estimate of benefits amount; and
if the amount owed to the healthcare provider associated with the healthcare encounter does not equal the total modified estimate of benefits amount, providing a notification.
